(19) United States
(12) Patent Application Publication
(10) Pub. No.: US 2019/0236526 A1
(43) Pub. Date: Aug. 1, 2019

(54) System and Method for Managing Visual Product Placement

(71) Applicant: Veeva Systems Inc., Pleasanton, CA (US)

(72) Inventor: Arno Sosna, Pleasanton, CA (US)

(73) Assignee: Veeva Systems Inc., Pleasanton, CA (US)

(21) Appl. No.: 15/885,656

(22) Filed: Jan. 31, 2018

(51) Int. Cl. G06Q 10/08; G06N 99/00; G06K 9/00; G06K 9/62

(52) U.S. Cl. CPC G06Q 10/087; G06N 99/005; G06Q 30/01; G06K 9/6202; G06K 9/6256; G06K 9/00671

(57) ABSTRACT

Systems and methods for managing visual product placement. A user computing device may have trained machine learning models to detect a shelf and a target product. A shelf may be detected by a computing device with a machine learning model, and the scope of the shelf may be divided into a number of small boxes, each corresponding to a product on the shelf. A first target product and its actual placement information may be detected with a machine learning model. The actual placement information may be compared with a set of requirements for visual placement of the first target product on the shelf. Deviation and adjustment to correct the deviation may be determined, and the adjustment may be displayed in an AR environment.

### BACKGROUND

The subject technology relates to product placement in retail.

Planogram is a diagram or model that indicates the placement of retail products on shelves in order to maximize sales. Manufacturers may have a contract with retailers specifying requirements for placement of their products on shelves, send people to stores to collect information about actual placement of their products, and then analyze the information to find out if the requirements are satisfied. It is desirable to provide a system and method for improving efficiency of the process.

### SUMMARY

The disclosed subject matter relates to a method for managing visual product placement. The method comprises: obtaining a real-time image of a place with a computing device; detecting a shelf in the real-time image of the place with a first machine learning model stored in the computing device; and dividing an image of the shelf into a plurality of small boxes, wherein each of the small boxes corresponds to an image of a product on the shelf. The method further comprises: detecting an image of a first target product in the plurality of small boxes with a second machine learning model stored in the computing device; and comparing actual product placement information of the first target product with a set of requirements for displaying the first target product on the shelf with the computing device.

### BRIEF DESCRIPTION OF THE DRAWINGS

FIG. 1 illustrates an example high level block diagram of a customer relationship management architecture wherein the present invention may be implemented.

FIG. 2 illustrates an example block diagram of a computing device.

FIG. 3 illustrates an example high level block diagram of a user computing device.

FIG. 4 illustrates an example flowchart of a method for obtaining trained machine learning model according to one embodiment of the present invention.

FIG. 5 illustrates an example flowchart of a method for managing visual product placement according to one embodiment of the present invention.

FIGS. 6, 7, 8 and 9 each illustrates an example user interface for managing visual product placement according to one embodiment of the present invention.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, the subject technology is not limited to the specific details set forth herein and may be practiced without these specific details. In some instances, well-known structures and components are shown in block diagram form in order to avoid obscuring the concepts of the subject technology.

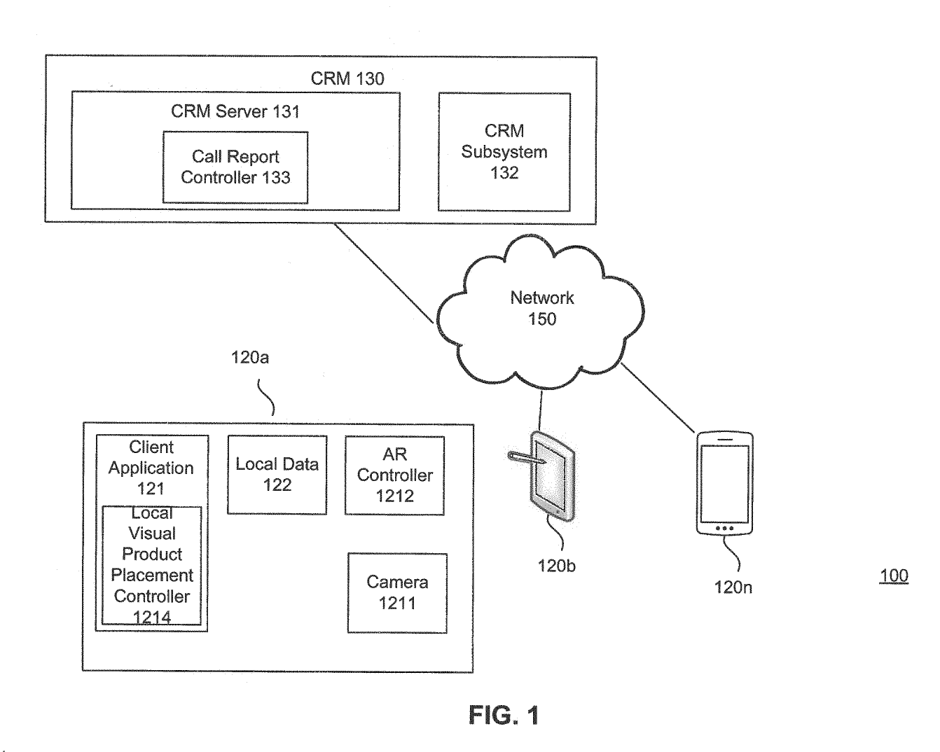

FIG. 1 illustrates an example high level block diagram of a customer relationship management architecture 100 wherein the present invention may be implemented. As shown, the architecture 100 may include a plurality of user computing devices 120a, 120b, . . . 120n, and a CRM 130, coupled to each other via a network 150. The CRM 130 may include a customer relationship management server 131, and a customer relationship management subsystem 132. The customer relationship management server 131 may further include a call report controller 133 which may have a visual product placement module. The network 150 may include one or more types of communication networks, e.g., a local area network (“LAN”), a wide area network (“WAN”), an intra-network, an inter-network (e.g., the Internet), a telecommunication network, and peer-to-peer networks (e.g., ad hoc peer-to-peer networks), which may be wired or wireless.

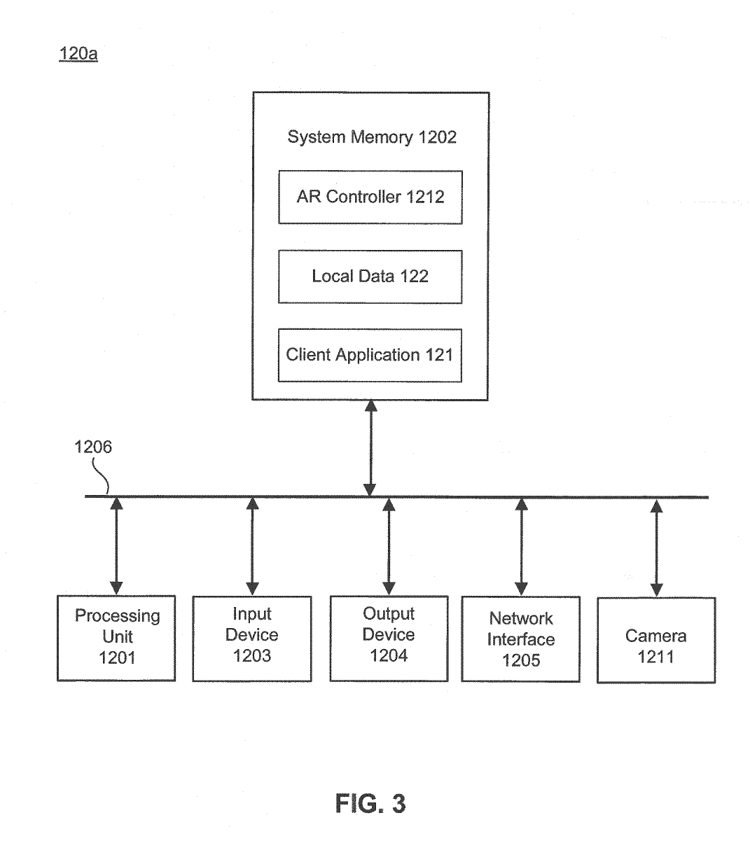

The user computing devices 120a-120n may be any machine or system that is used by a user to access the CRM 130 via the network 150, and may be any commercially available computing devices including laptop computers, desktop computers, mobile phones, smart phones, tablet computers, netbooks, and personal digital assistants (PDAs). A CRM client application 121 may run from a user computing device, e.g., 120a, and access the CRM 130 via the network 150. A local visual product placement controller 1214 may be trained to recognize a store shelf and a target product. Local data 122 may be a subset of data from the customer relationship management subsystem 132 which may be needed to support operation of the mobile application 121. The local data 122 may include account data, product data, a trained machine learning model, and contractual planogram information. An AR controller 1212 may receive AR content from the local visual product placement controller 1214 and a real time video from a camera 1211, and overlay the AR content over the real time video in an AR environment. User computing devices 120a-120n are illustrated in more detail in FIG. 3.

The customer relationship management server 131 is typically a remote computer system accessible over a remote or local network, such as the network 150, and may provide access to the customer relationship management subsystem 132. The customer relationship management server 131 could be any commercially available computing devices. A client application (e.g., 121) process may be active on one or more user computing devices 120a-120n. The corresponding server process may be active on the customer relationship management server 131. The client application process and the corresponding server process may communicate with each other over the network 150, thus providing distributed functionality and allowing multiple client applications to take advantage of the information-gathering capabilities of the CRM 130.

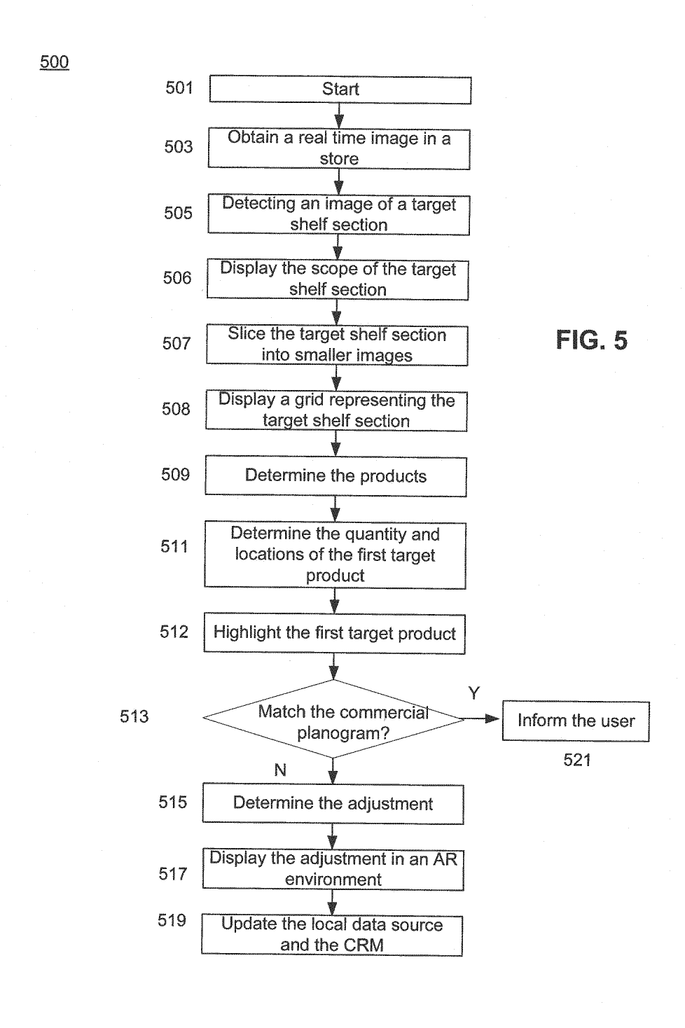

In one implementation, the call report controller 133 in the customer relationship management server 131, or its visual product placement module, may receive data related requirements for placement of a customer's products on shelves (e.g., contractual planogram), and actual placement of the customer's products on shelves, and monitor planograms of target stores, as will be described with reference to FIG. 5 below.

In one implementation, the customer relationship management subsystem 132 stores contact information that may be available to users. In addition to contact information, the customer relationship management subsystem 132 can also store configurations regarding specific preferences, regulatory limitations and requirements, and other fields that will facilitate communications, in general or on a by-recipient basis.

In one implementation, the customer relationship management subsystem 132 can communicate with multiple sources through the customer relationship management server 131 or through other channels to maintain a current and accurate collection of information regarding customer accounts, which may include group accounts and individual accounts. The interface with the multiple sources can be, for example, through an Application Programming Interface or API, as the API interface will allow compatibility with a flexible array of third-party provider servers. The information being updated may include, but is not limited to, licensing information, area of practice, and location of the various customer accounts. In this manner, the customer relationship management subsystem 132 pulls the approved version of what represents an account, which may be a hospital or physician, and pulls from multiple networks to ensure that the information regarding an account is up-to-date.

In one implementation, the customer relationship management subsystem 132 may be operated by a third party.

In one implementation, the CRM 130 may be a multi-tenant system where various elements of hardware and software may be shared by one or more customers. For instance, a server may simultaneously process requests from a plurality of customers. In a multi-tenant system, a user is typically associated with a particular customer. In one example, a user could be an employee of one of a number of pharmaceutical companies which are tenants, or customers, of the CRM 130.

Although the embodiments are described with a customer relationship management subsystem 132, the customer information and content may be from other types of information management systems, e.g., a Closed Loop Marketing (CLM) system. Other types of data storage systems may be used as well.

In one embodiment, the CRM 130 may run on a cloud computing platform. Users can access content on the cloud independently by using a virtual machine image, or purchasing access to a service maintained by a cloud database provider. The customer relationship management subsystem 132 may be a cloud-based customer database that provides a central access to store and distribute consistent data across customer companies as well as their possible third-party partners and agencies that are used to keep this data updated. This system can provide standard data formats and provide an easy and automated way for customers to have access to coordinated and frequently updated CRM data.

In one embodiment, the CRM 130 may be provided as Software as a Service (“SaaS”) to allow users to access it with a thin client.

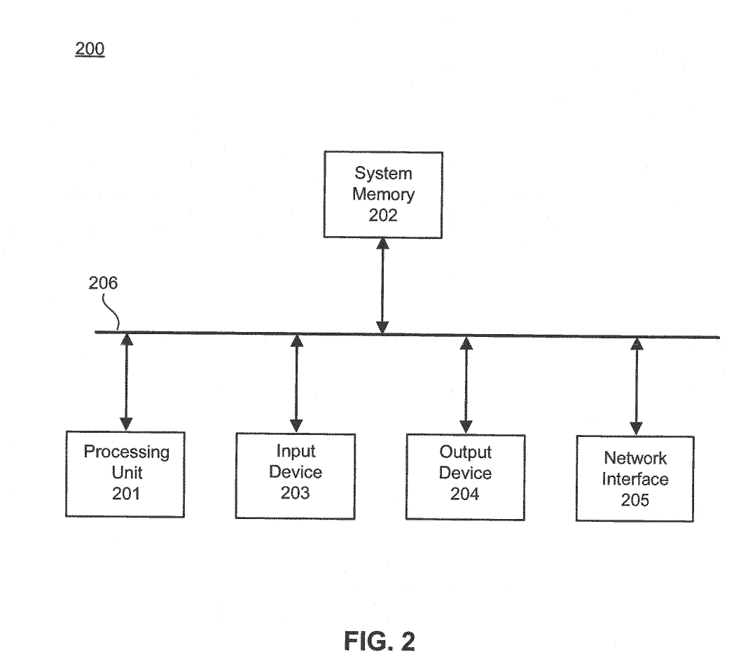

FIG. 2 illustrates an example block diagram of a computing device 200 which can be used as the user computing devices 120a-120n, and the customer management relationship server 131 in FIG. 1. The computing device 200 is only one example of a suitable computing environment and is not intended to suggest any limitation as to scope of use or functionality. The computing device 200 may include a processing unit 201, a system memory 202, an input device 203, an output device 204, a network interface 205 and a system bus 206 that couples these components to each other.

The processing unit 201 may be configured to execute computer instructions that are stored in a computer-readable medium, for example, the system memory 202. The processing unit 201 may be a central processing unit (CPU).

The system memory 202 typically includes a variety of computer readable media which may be any available media accessible by the processing unit 201. For instance, the system memory 202 may include computer storage media in the form of volatile and/or nonvolatile memory such as read only memory (ROM) and/or random access memory (RAM). By way of example, but not limitation, the system memory 202 may store instructions and data, e.g., an operating system, program modules, various application programs, and program data.

A user can enter commands and information to the computing device 200 through the input device 203. The input device 203 may be, e.g., a keyboard, a touchscreen input device, a touch pad, a mouse, a microphone, and/or a pen.

The computing device 200 may provide its output via the output device 204 which may be, e.g., a monitor or other type of display device, a speaker, or a printer.

The computing device 200, through the network interface 205, may operate in a networked or distributed environment using logical connections to one or more other computing devices, which may be a personal computer, a server, a router, a network PC, a peer device, a smart phone, or any other media consumption or transmission device, and may include any or all of the elements described above. The logical connections may include a network (e.g., the network 150) and/or buses. The network interface 205 may be configured to allow the computing device 200 to transmit and receive data in a network, for example, the network 150. The network interface 205 may include one or more network interface cards (NICs).

FIG. 3 illustrates an example high level block diagram of a user computing device (e.g., 120a) wherein the present invention may be implemented. The user computing device 120a may be implemented by the computing device 200 described above, and may have a processing unit 1201, a system memory 1202, an input device 1203, an output device 1204, a network interface 1205, and a camera 1211, coupled to each other via a system bus 1206. The system memory 1202 may store the CRM client application 121, the local data 122, and an AR controller 1212. The client application 121 may have a local visual product placement controller 1214.

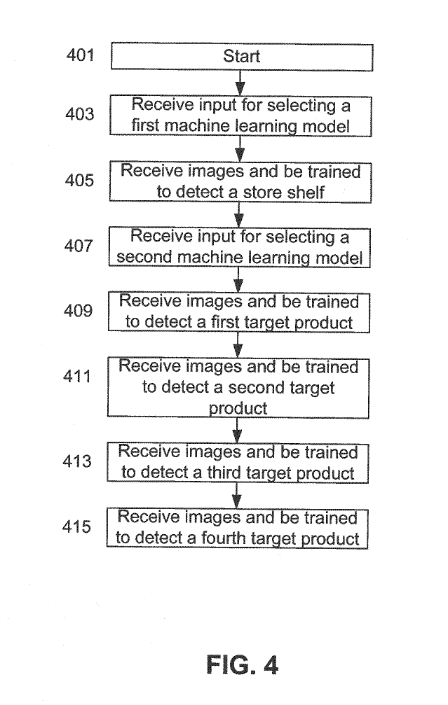

The mobile application (e.g., 121) process may be active on the user computing device 120a. A corresponding server process may be active on the customer relationship management server 131. The client application process and the corresponding server process may communicate with each other over a network, thus providing distributed functionality and allowing multiple client applications to take advantage of the information-gathering capabilities of the CRM system, including the customer relationship management server 131 and the customer relationship management subsystem 132. The mobile application 121 with its corresponding server process may control the process for generating a call report, and the process for managing visual product placement, as will be described below with reference to FIGS. 4 and 5.

The local visual product placement controller 1214 may be trained to detect a store shelf and a number of target products with a selected machine learning model.

The local data 122 in the user computing device 120a may be a subset of data from the customer relationship management subsystem 132 which may be needed to support operation of the mobile application 121. The local data 122 may be synchronized with the customer relationship management subsystem 132 regularly, when the user computing device 120a is back online, and/or when the user requests for synchronization. In one implementation, the local data source 122 may be a subset of data from the customer relationship management subsystem 132 which is available to a user based on the content access control rule. The local data 122 may include requirements for placement of a customer's products on shelves, and one or more trained machine learning model for detecting shelf and products.

A variety of machine learning model types may be integrated into the client application 121 and supported by the local visual product placement controller 1214. The machine learning model types may support extensive deep learning, and standard models such as tree ensembles, SVMs, and generalized linear modes. The machine learning models may run on the user computing device, so that data can be analyzed locally on the user computing device. The local visual product placement controller 1214 can support computer vision machine learning features, which may include, e.g., detecting a shelf in a retail store, and detecting the image of a target product. Examples of the machine learning model include Keras and Tensorflow.

FIG. 4 illustrates an example flowchart of a method for obtaining trained machine learning model according to one embodiment of the present invention. The process may start at 401.

At 403, the local visual product placement controller 1214 may receive an input for selecting a first machine learning model for detecting a store shelf

At 405, the local visual product placement controller 1214 may receive a number of images and be trained to detect a store shelf with the first machine learning model.

At 407, the local visual product placement controller 1214 may receive an input for selecting a second machine learning model for detecting the customer's target product.

At 409, the local visual product placement controller 1214 may receive a number of images and be trained to detect the customer's target product with the second machine learning model. The images may be packages of a number of target products (including images from different angles).

It should be appreciated that the first machine learning model and the second machine learning model may be the same model.

The local visual product placement controller 1214 may be trained to detect more target products, as shown in 411-415.

FIG. 5 illustrates an example flowchart of a method for managing visual product placement according to one embodiment of the present invention. The process may start at 501.

At 503, a user (e.g., an employee of a customer of the system 100) may point a camera in a user computing device 120a (e.g., a portable computer, a tablet or a mobile phone) at a shelf in a store.

At 505, a target shelf section (e.g., a pharmacy shelf) may be detected, e.g., by the local visual product placement controller 1214, from the image on the screen of the user computing device 120a. A first machine training model may be used to detect the target shelf section by its shape or contour.

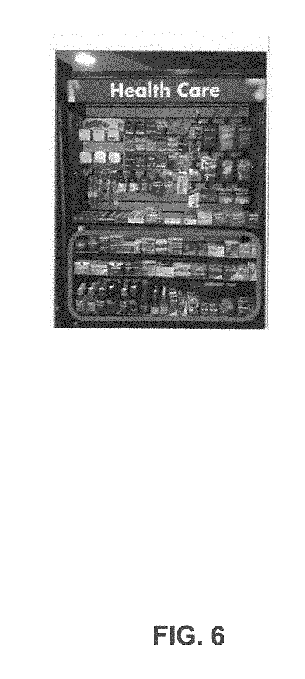

At 506, as shown in FIG. 6, the scope of the target shelf section may be marked on the screen of the user computing device. In one implementation, the scope of the target shelf section may be displayed in an AR environment, in which the scope of the target shelf section is displayed as a piece of AR content overlaid over a real-time video of the shelf from the camera 1211.

At 507, the target shelf section may be sliced into a number of smaller images, e.g., by using heuristics with the local visual product placement controller 1214. Each of the smaller images may correspond to the package of a product on the shelf. The smaller images may include the image of a first target product and a second target product.

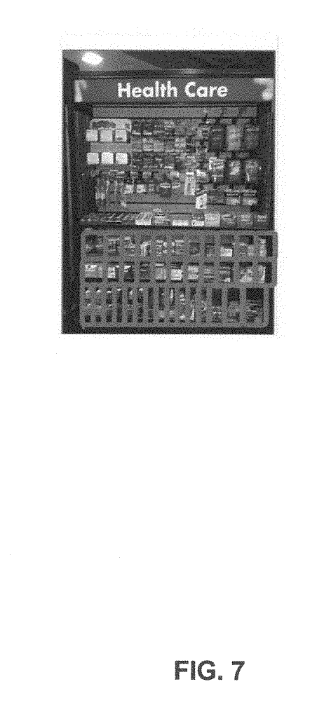

At 508, as shown in FIG. 7, a grid representing the target shelf section and the smaller images may be displayed on the user computing device 120a. In one implementation, the grid may be displayed in an AR environment, in which the grid is displayed as a piece of AR content overlaid over the real-time video of the shelf from the camera 1211.

At 509, it may be determined, e.g., by the local visual product placement controller 1214, the products corresponding to the smaller images. The first or second machine learning model may be used to detect the products. Images of the packages of a number of products may be used to build the machine learning model in advance,

At 511, information of the first target product on the shelf may be obtained, including its quantity and locations.

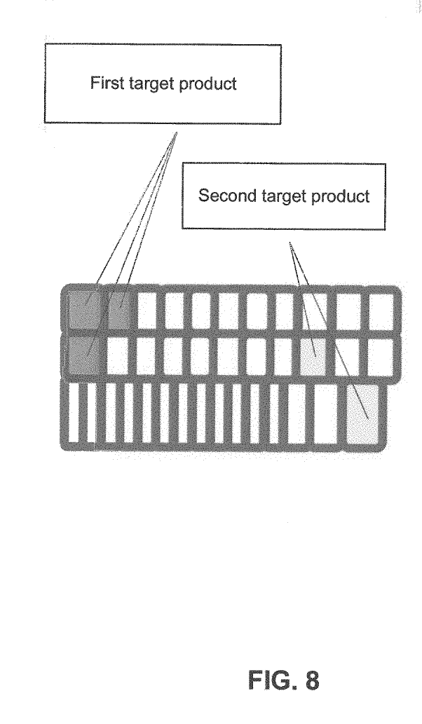

At 512, as shown in FIG. 8, the first target product may be highlighted on the screen of the user computing device.

At 513, the quantity and locations of the first target product may be matched against the customer's requirements for placement of their products on shelves (e.g., contractual planogram), by the local visual product placement controller 1214. The contractual planogram may specify the desired way to arrange and display the target product on the shelf, e.g., three boxes of the first target product next to each other in the second row of the shelf In one implementation, a planogram management algorithm may be used to determine if the quantity and locations of the first target product match the contractual planogram.

If they match, the user may be informed at 521.

If the quantity and locations of the first target product do not match the contractual planogram, the adjustment needs to be made to correct the deviation may be determined by the local visual product placement controller 1214 at 515.

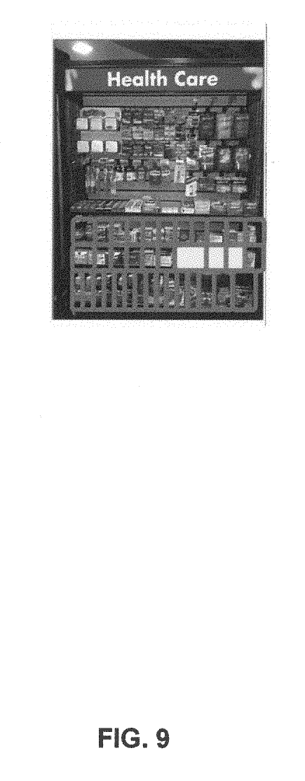

At 517, the adjustment may be displayed on the user computing device 120a. It can tell the user immediately, in real time, how to arrange the first target product(s) on the target shelf section based on the contractual planogram. In one implementation, as shown in FIG. 9, the adjustment may be displayed in an AR environment, with the grid being overlaid over the real-time video of the shelf from the camera 1211, and correct quantity and locations of the first target product highlighted. The AR controller 1212 may overlay the grid over the real-time video to present AR content.

At 519, the result may be saved to the local data 122, and synchronized to the CRM subsystem 132. Other information collected during the process may be saved and synchronized too, e.g., the location of the store, the time of the visit, and product information.

The present invention performs image recognition on the user computing device, and uses the planogram information synchronized down to the user computing device from the CRM system 130. No connectivity to the Internet is required, and no need to wait for analysis from a remote system. The user may get the result in almost real time, without sending data out to a remote system. The client application may use machine learning and image recognition, directly on the user computing device,

The above-described features and applications can be implemented as software processes that are specified as a set of instructions recorded on a computer readable storage medium (also referred to as computer readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

These functions described above can be implemented in digital electronic circuitry, in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

In this specification, the term “software” is meant to include firmware residing in read-only memory or applications stored in magnetic storage, which can be read into memory for processing by a processor. Also, in some implementations, multiple software technologies can be implemented as sub-parts of a larger program while remaining distinct software technologies. In some implementations, multiple software technologies can also be implemented as separate programs. Finally, any combination of separate programs that together implement a software technology described here is within the scope of the subject technology. In some implementations, the software programs, when installed to operate on one or more electronic systems, define one or more specific machine implementations that execute and perform the operations of the software programs. Examples of computer programs or computer code include machine code, for example is produced by a compiler, and files including higher-level code that are executed by a computer, an electronic component, or a microprocessor using an interpreter.

A computer program (also known as a program, software, software application, script, or code) can be written in any form of programming language, including compiled or interpreted languages, declarative or procedural languages, and it can be deployed in any form, including as a stand alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

It is understood that any specific order or hierarchy of steps in the processes disclosed is an illustration of example approaches. Based upon design preferences, it is understood that the specific order or hierarchy of steps in the processes may be rearranged, or that all illustrated steps be performed. Some of the steps may be performed simultaneously. For example, in certain circumstances, multitasking and parallel processing may be advantageous. Moreover, the separation of various system components illustrated above should not be understood as requiring such separation, and it should be understood that the described program components and systems can generally be integrated together in a single software product or packaged into multiple software products.

Various modifications to these aspects will be readily apparent, and the generic principles defined herein may be applied to other aspects. Thus, the claims are not intended to be limited to the aspects shown herein, but is to be accorded the full scope consistent with the language claims, where reference to an element in the singular is not intended to mean “one and only one” unless specifically so stated, but rather “one or more.” Unless specifically stated otherwise, the term “some” refers to one or more.

What is claimed is:

1. A computer-implemented method for managing visual product placement, the method comprising:
obtaining a real-time image of a place with a camera in a local computing device;
detecting a shelf in the real-time image of the place by a visual product placement controller with a first machine learning model stored in the local computing device;
dividing an image of the shelf into a plurality of small boxes with the visual product placement controller in the local computing device, wherein each of the small boxes corresponds to an image of a product on the shelf;
detecting an image of a first target product in the plurality of small boxes by the visual product placement controller with a second machine learning model stored in the local computing device; and
comparing actual product placement information of the first target product with a set of contractual planogram requirements for displaying the first target product on the shelf with the visual product placement controller in the local computing device.

2. The method of claim 1, further comprising: when the actual product placement information of the first target product and the set of requirements for displaying the first target product on the shelf do not match, determining an adjustment to correct a deviation.

3. The method of claim 2, further comprising: displaying the adjustment to correct the deviation.

4. The method of claim 3, wherein the adjustment is displayed in an augmented reality (“AR”) environment, with a grid representing the small boxes overlaid over a real time image of the shelf.

5. The method of claim 4, wherein a small box meeting the set of requirements for displaying the first target product on the shelf is highlighted.

6. The method of claim 3, wherein the actual product placement information comprises a quantity of the first target product on the shelf.

7. The method of claim 3, wherein the actual product placement information comprises a location of the first target product on the shelf.

8. The method of claim 3, further comprising: displaying the shelf in an AR environment, with a grid representing the small boxes overlaid over a real-time image of the shelf.

9. The method of claim 3, further comprising: detecting an image of a second target product in the plurality of small boxes with the second machine learning model stored in the local computing device

10. The method of claim 1, wherein the first machine learning model is the second machine learning model.

11. The method of claim 2, further comprising: storing the adjustment on the local computing device.

12. The method of claim 11, further comprising: synchronizing the adjustment to a remote information management system.

13. The method of claim 12, wherein the remote information management system is a customer relationship management (“CRM”) system.

14. The method of claim 1, further comprising: receiving a plurality of images for training the first machine learning model to detect the shelf at the local computing device.

15. The method of claim 1, further comprising: receiving a plurality of images for training the second machine learning model to detect the first target product at the local computing device.

16. The method of claim 1, further comprising: detecting an image of a second target product in the plurality of small boxes with the second machine learning model stored in the local computing device.

17. The method of claim 1, further comprising: determining actual product placement information of the first target product.

18. A system for managing visual product placement, comprising:
a local storage device for storing local data; and
a local visual product placement controller for:
detecting a shelf in a real-time image of a place from a camera with a first machine learning model stored in a first computing device;
dividing an image of the shelf into a plurality of small boxes, wherein each of the small boxes corresponds to an image of a product on the shelf;
detecting an image of a first target product in the plurality of small boxes with a second machine learning model stored in the first computing device; and
comparing actual product placement information of the first target product with a set of contractual planogram requirements for displaying the first target product on the shelf with the computing device.

19. The system of claim 18, wherein the controller further determines an adjustment to correct a deviation when the actual product placement information of the first target product and the set of requirements for displaying the first target product on the shelf do not match.

20. The system of claim 18, wherein the actual product placement information comprises a quantity of the first target product on the shelf.
